(19) United States
(12) Patent Application Publication
(10) Pub. No.: US 2010/0023228 A1
(43) Pub. Date: Jan. 28, 2010

(54) APPARATUS AND METHOD FOR THE POSITIONING OF A TOOL OF A GROUND ENGAGING VEHICLE

(76) Inventor: James L. Montgomery, Dubuque, IA (US)

Correspondence Address: TAYLOR & AUST, P.C., P.O. Box 560, 142. S Main Street, Avilla, IN, 46710, US

(21) Appl. No.: 11/777,458

(22) Filed: Jul. 13, 2007

(51) Int. Cl. G06F 7/00; G01S 1/00

(52) U.S. Cl. 701/50; 342/357.09

(57) ABSTRACT

A ground engaging vehicle including a ground engaging tool, an actuator, a global positioning system (GPS) and a control system. The ground engaging tool extends from the vehicle, and has a reference feature. The actuator is connected to the ground engaging tool, and the actuator is configured to move the ground engaging tool relative to the vehicle. The actuator has a position sensor associated therewith. The GPS is positioned in a substantially fixed position relative to the reference feature. The GPS issues three dimensional location information. The control system is configured for receiving positional information from the position sensor and the three dimensional location information. The control system is also configured for processing the location information and sending a command to a non-GPS constrained algorithm that receives the command and determines a movement of the actuator dependent on a difference between the location information and a desired position of the reference feature. The non-GPS constrained algorithm issues a movement instruction to the actuator dependent upon the difference and the positional information.

### FIELD OF THE INVENTION

The present invention relates to the positioning of a tool of a ground engaging vehicle, and, more particularly to the positioning of a tool in a moving ground engaging vehicle.

### BACKGROUND OF THE INVENTION

Technologies for tracking moving objects exist in several environments including the tracking of airplanes, automobiles, persons, and even sporting objects such as a hockey puck. One technology that has become popular for tracking objects is the use of global positioning system (GPS). GPS is a satellite based navigation system operated and maintained by the U.S. Department of Defense. GPS consists of a constellation of satellites that provide worldwide, 24 hour, three-dimensional navigational services. By computing the distance to GPS satellites orbiting the earth, a GPS receiver can calculate an accurate position of itself. This process is called satellite ranging and can result in a position being tracked relative to the GPS receiver and its position relative to the orbiting satellites. Other national governments have launched satellite ranging systems. In particular the Russian government operates the GLONASS system. The European Union is currently developing a third satellite ranging system.

The calculations made by the GPS receiver involves the calculation of the distance between the receiver and three or more GPS satellites. The distance is calculated by measuring the time delay between transmission and reception of each GPS signal, the delay being analogous to the distance to each satellite, since the signal travels at a known speed. The signals also carry information about the satellites' locations and by determining the position of the satellite and the distance to at least three satellites the receiver can compute the position using trilateration. Receivers typically do not have a highly accurate clock in order to measure the delay as such timing information to track the satellites is also received from the satellites in the form of clock correction signals.

The satellites orbit at approximately 12,600 miles and typically make two complete orbits each day so that they pass over the same location of earth once a day, since the earth is rotating as well. The orbits are arranged so that typically at least six satellites are always within line of sight from almost anywhere on the surface of the earth.

A GPS receiver typically includes an antenna, a tuned receiver that is tuned to the frequencies transmitted by the satellites, a processor and a highly stable clock. A display is often also included with the GPS receiver to provide output information such as location and speed. To calculate the position the receiver needs to know the precise time and the internal clock is continually updated using the signals from the satellites. The receiver identifies each satellite signal by its distinctive course/acquisition code pattern then measures the time delay of the signal received from each satellite.

There are a number of errors associated with GPS signals including ranging errors due to the earths ionosphere and atmosphere, noise, multi-path satellite clocks and other errors. Additionally, the basic geometry of the satellite system can itself magnify certain errors.

One known enhancement to standard GPS technology includes the technique of differential GPS, which involves the use of reference GPS receiver that is stationary and is precisely located on a position that has been accurately surveyed. The satellite signals that are being received have a high spatial and temporal correlation in its errors. So if two receivers are fairly close to each other, for example less than one mile, the signals that reach both of them will have traveled through virtually the same slice of atmosphere and will have virtually the same errors. With differential GPS the stationary reference receiver is used to measure the errors. The reference receiver then provides an error correction signal to the other roving receivers. In this way the systemic errors can be reduced since the error calculated by the stationary GPS system is then broadcast to the roving receivers. The reference receiver provides these error signals to the roving receivers. The reference receiver figures out what the travel time of the GPS signal should be and compares it to what they actually are. The difference is used to identify the error information transmitted to the roving receivers. The roving receivers apply the differential corrections that are broadcast from the stationary receiver to significantly reduce the error of the location resolved from the GPS signals at the roving receiver.

While static positional errors can be largely removed in the foregoing technique, there remains time delays associated with obtaining the information so that a moving object can be accurately controlled. The GPS system updates the positional information several times a second. However, if the item to be tracked is moving at several feet per second, the precise position is essentially unknown between the GPS updates. This can typically cause variations in working elements of a tool, for example a tool being driven by a vehicle, and can lead to oscillations or inaccuracies of the positioning of the tool.

What is needed in the art is a method to control the positioning of a tool between positional updates of a position detecting system.

### SUMMARY OF THE INVENTION

The invention includes a ground engaging vehicle including a ground engaging tool, an actuator, a global positioning system (GPS) and a control system. The ground engaging tool extends from the vehicle, and has a reference feature. The actuator is connected to the ground engaging tool, and the actuator is configured to move the ground engaging tool relative to the vehicle. The actuator has a position sensor associated therewith. The GPS is positioned in a substantially fixed position relative to the reference feature. The GPS issues three dimensional location information. The control system is configured for receiving positional information from the position sensor and the three dimensional location information. The control system is also configured for processing the location information and sending a command to a non-GPS constrained algorithm that receives the command and determines a movement of the actuator dependent on a difference between the location information and a desired position of the reference feature. The non-GPS constrained algorithm issues a movement instruction to the actuator dependent upon the difference and the positional information.

Another embodiment of the invention includes a method of controlling the position of an actuator associated with a vehicle having the steps of receiving an updated GPS output, determining a difference between a current position and a desired position of a tool, and sending a command containing the difference to a non-GPS constrained algorithm. The receiving step receives an updated GPS output relative to a position of an earth encountering tool attached to the vehicle. The determining step includes determining a difference between a current position and a desired position of the tool. The tool is connected to the actuator. The non-GPS constrained algorithm includes the steps of receiving the command, determining a movement of the actuator dependent upon the difference computed and moving the actuator dependent upon the step of determining a movement.

### BRIEF DESCRIPTION OF THE DRAWINGS

FIG. 1 is a side view of a ground engaging vehicle using an embodiment of a tool adjusting method of the present invention;

FIG. 2 is a schematicized side view of a ground engaging tool positioned by the tool adjustment method used in FIG. 1;

FIG. 3 is a schematicized block diagram of part of the tool positioning method utilized in the system of FIGS. 1 and 2; and

FIG. 4 is a schematicized block diagram of steps utilized by the method used by the elements in FIGS. 1 and 2 and receptive of a command from the method of FIG. 3.

### DETAILED DESCRIPTION OF THE INVENTION

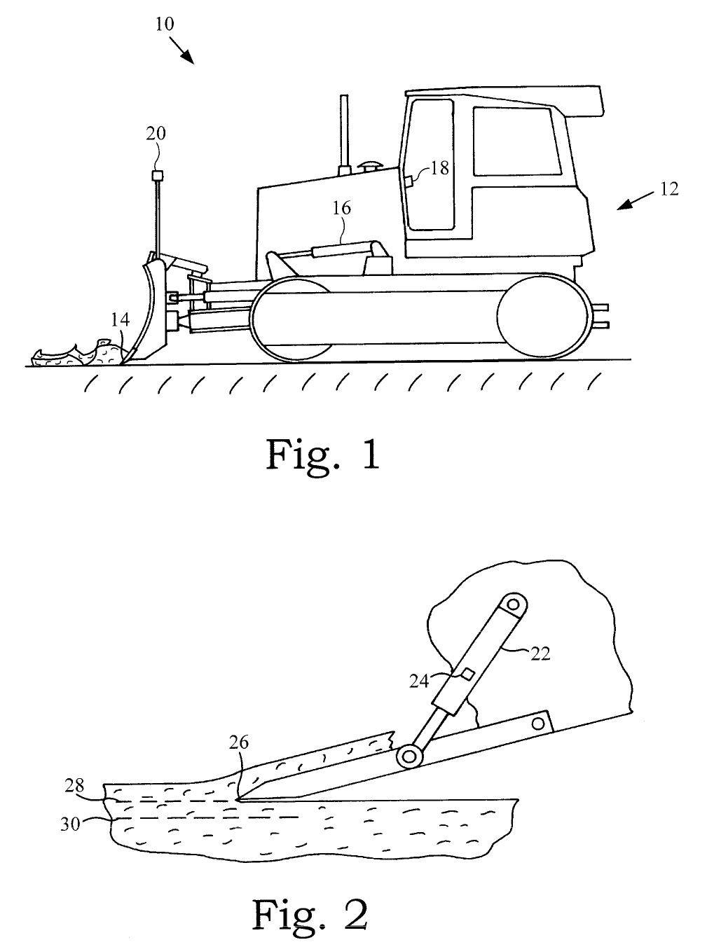

Referring now to the drawings, and more particularly to FIGS. 1 and 2 there is shown a ground engaging vehicle system 10 including a tracked vehicle 12, a blade edge 14, hydraulic cylinders 16, a control system 18 and a GPS system 20. Tracked vehicle 12 is representative of a ground engaging vehicle 12 that in this case is pushing blade edge 14 along an earth encountering path. Blade edge 14, also known as a ground engaging tool 14, is positioned by way of hydraulic cylinders 16 under the control of an operator and control system 18.

As mentioned above governments in addition to the United States have launched satellite ranging systems. In particular the Russian government operates the GLONASS system, and the European Union is currently developing a satellite ranging system. The present invention refers to GPS system 20, and this term is meant to include any satellite positioning systems and not to be limited to a U.S. satellite positioning system. For the sake of clarity, references herein to a GPS system shall be understood to refer to any satellite positioning system.

The position between blade edge 14, which can be considered a reference feature 14, and GPS system 20 is measured in both vertical and horizontal directions so that the positioning of blade edge 14 is known relative to GPS system 20 so that the position of blade edge 14 is then known relative to the entire work site. Additionally, attitude sensors associated with blade edge 14, which may be in the form of positional sensors associated with hydraulic cylinders 16 provide information as to the three-dimensional positioning of the entire length of blade edge 14. Control system 18 interfaces with the positional sensors of blade edge 14 and hydraulic cylinders 16 along with information from GPS system 20 to control the position of blade edge 14 as it moves along the ground surface. When the ground speed of tracked vehicle 12 exceeds approximately 3-5 miles per hour a certain amount instability in the position control system of prior art systems is noted in that the ground engaging tool will oscillate around the a nominal position when operating above this limiting ground speed. At least to some degree the variability may be attributed to variability in the rate of actuation of hydraulic cylinders 16. This rate varies due to engine speed and load, hydraulic pressures and flows and the load on the ground engaging tool. The load on the ground engaging tool includes the hardness and/or the moisture content of the soil or material that is manipulated by the tool.

The common limiting parameter that explains this instability is the update rate of the position signal available by way of the GPS receiver. A typical GPS receiver outputs a NEMA standard serial record at 100 milliseconds per record, or ten times per second. The rate of change in the target height of the ground as well as the slope of the surface to be milled or graded by cutting tool 14 in relation to the distance covered by the machine over the basic control cycle time period contributes to the required slew rate of the tool to achieve the desired features of the surface map of the construction area. An increase in the slew rate decreases the stability of the closed loop system with a fixed control period. Results can be observed with this increased slew rate as an increased step response overshoot. This overshoot contributes to the oscillatory behavior observed in prior art units. Prior art attempts to dampen the oscillation result in positional errors.

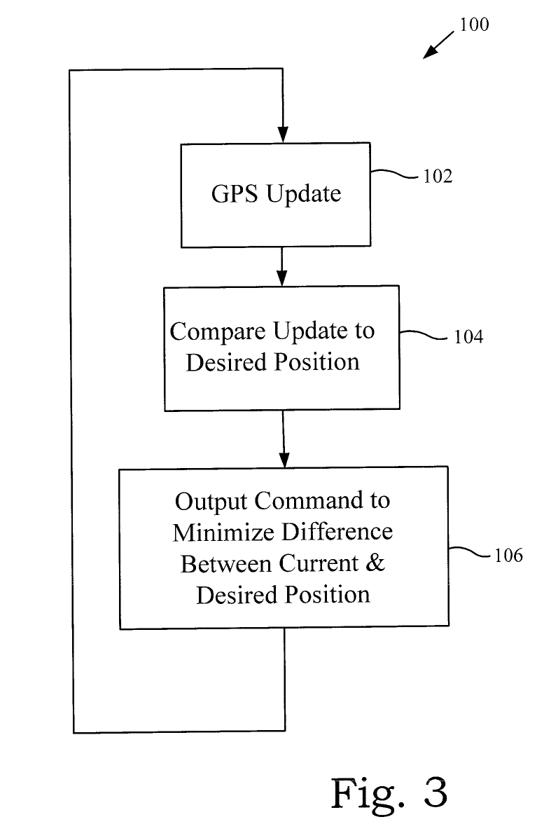

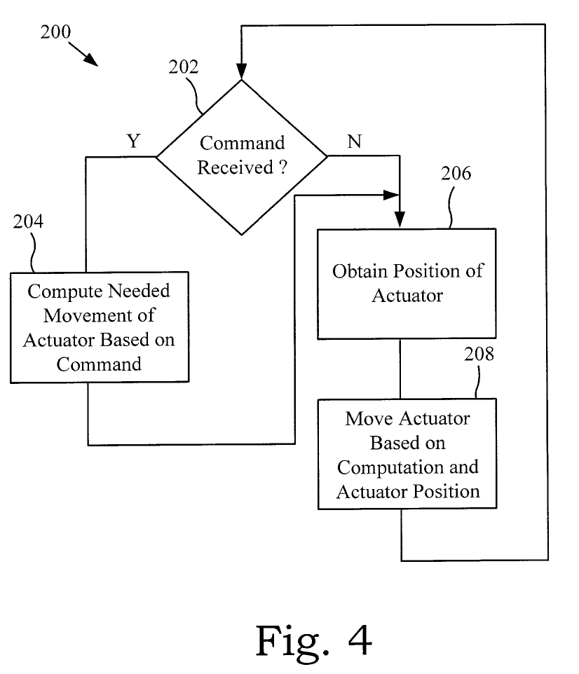

In the present invention the limitations due to the GPS updating are overcome in that control system 18 utilizes two algorithms that are only loosely tied together for the positioning of blade edge 14. Now, further referring to FIGS. 3 and 4 there are illustrated methods 100 and 200 of the present invention. For ease of illustration of the method, a single actuator 22 is shown in FIG. 2 having a position sensor 24 for the positioning of blade edge 26. The method is applicable to additional actuators under the control of control system 18. Actuator 22 can be thought of as one of hydraulic cylinders 16 under the control of control system 18 that receives information from position sensor 24 for the adjustment of blade edge 26, which is a schematical representation of blade edge 14. Position sensor 24 resolves the extension and/or rotation of at least a portion of actuator 22. Cutting level 28 is the current edge position that blade edge 26 will cut as ground engaging vehicle 12 proceeds in a direction from right to left. Cutting level 30 represents the desired position of blade edge 26.

Method 100 includes a GPS update of GPS system 20 that occurs at step 102. GPS system 20 has a known locational difference in geometrical position from blade edge 14, 26 so that the location of GPS system 20 location is translated into a position of blade edge 26. This translation is understood to take place to provide a position of blade edge 14, 26. At step 104, control system 18 determines that the desired position 30 of blade edge 26 is different from the current position 28 of blade edge 26. This leads to step 106, in which a command is output to minimize the difference between the current position 28 and the desired position 30. The command may be a relative command representative of the difference between positions 28 and 30. As tracked vehicle 12 proceeds at a speed that may exceed 5 miles per hour, in order to avoid oscillating about desired position 30, the command from method 100 is sent, at step 106, to method 200 for execution.

Method 200 can be thought of as an inner control loop operating in a more rapid fashion than the outer control loop of method 100. The inner control loop is executed at a substantially faster rate than the outer GPS referenced control loop to add stability to the control system and to reduce oscillatory behavior of blade edge 14, 26. This allows the ground speed of the vehicle 12 to be increased while maintaining and/or improving the positional tolerance of system 10 over that of a single loop control system. When a command is received at step 202, that has been output at step 106, method 200 computes or determines the needed movement of actuator 22 based on the received command. For example, if the difference between current position 28 and desired position 30 is one inch, method 200 determines and/or calculates the movement of actuator 22 based on its geometrical position relative to blade edge 26, and how the quickly to move blade edge 26 by movement of actuator 22. At step 206, the position of actuator 22 is obtained by receiving a signal from position sensor 24. At step 208, actuator 22 is moved based upon the computation of the needed movement based upon minimizing the error between the desired position of actuator 22 relative to its current position. Steps 206 and 208 repeat until another command is received from method 100. Method 200 executes steps 206 and 208 at a much higher rate than the reception of the command from method 100. The execution of steps 206 and 208 is at least ten times as fast as the execution of method 100 in that positioning of actuator 22 is monitored a multitude of times between GPS updates.

Position sensor 24 may be integral with actuator 22 or be added on to actuator 22. While shown schematically, the tool having blade edge 26 can be thought of as any ground engaging tool being positioned by actuator 22. The interaction between method 100 and method 200 operates to drive the outer loop positional error to zero and to maintain it between GPS updates. Inner loop method 200 is used to increase the step response of movement of actuator 22 and to minimize overshoot resulting in a faster slew rate for blade edge 26 without the oscillatory behavior currently observed in prior art systems. Advantageously, the present invention improves the system stability and allows for an increased ground speed with acceptable surface positional tolerances of the ground after being encountered by blade edge 26. This results in increased productivity for a closed loop grade control system.

While only a two dimensional view has been presented in FIGS. 1 and 2, it is to be understood that the positioning of blade edge 26 is controlled along the entire edge. The position of blade edge 26, which is detected by position sensors along portions of the blade and/or hydraulic operating system, is calibrated and coordinated with GPS system 20 by the interaction of control system 18, as control system 18 also receives information relative to a desired surface map and operational grades that are desired for the ground surface. The surface map of the worksite may be downloaded to control system 18 or portions of it may be provided to control system 18 based upon the location of vehicle 12.

Having described the preferred embodiment, it will become apparent that various modifications can be made without departing from the scope of the invention as defined in the accompanying claims.

1. A ground engaging vehicle, comprising:
a ground engaging tool extending from the vehicle, said ground engaging tool having a reference feature;
an actuator connected to said ground engaging tool, said actuator configured to move said ground engaging tool relative to said vehicle, said actuator having a position sensor associated therewith;
a Global Positioning System (GPS) positioned in a substantially fixed position relative to said reference feature, said GPS issuing three dimensional location information; and
a control system configured for:
receiving positional information from said position sensor and said three dimensional location information from said GPS;
processing said location information; and
sending a command to a non-GPS constrained algorithm that receives said command, said algorithm determining a movement of said actuator dependent on a difference between said location information and a desired position of said reference feature, said non-GPS constrained algorithm issuing a movement instruction to said actuator dependent upon said difference and said positional information.

2. The ground engaging vehicle of claim 1, wherein said algorithm is executed a plurality of times for each time a new one of said GPS three dimensional location information is available.

3. The ground engaging vehicle of claim 2, wherein said plurality of times is at least 10 times.

4. The ground engaging vehicle of claim 2, wherein said algorithm obtains said position of said actuator from said position sensor.

5. The ground engaging vehicle of claim 4, wherein said control system minimizes said difference between said location information and said desired position of said reference feature in less time than said GPS issues said three dimensional information.

6. The ground engaging vehicle of claim 5, wherein said control system receives a signal from said position sensor associated with said actuator, said signal being analogous to a position of said actuator.

7. The ground engaging vehicle of claim 1, wherein said reference feature is a cutting edge.

8. A ground engaging vehicle, comprising:
a blade extending from the vehicle, said blade having a cutting edge;
an actuator connected to said blade, said actuator configured to move said blade relative to said vehicle, said actuator having a position sensor associated therewith;
a Global Positioning System (GPS) positioned in a substantially fixed position relative to said cutting edge; and
a control system configured for:
associating a position of said cutting edge with a position of said actuator;
receiving an output from said GPS relative to a current position of said cutting edge;
determining a difference between said current position and a desired position of said cutting edge; and
sending a command containing said difference to a non-GPS constrained algorithm, said algorithm including the steps of:
receiving said command;
determining a movement of said actuator dependent on said difference; and
moving said actuator dependent upon said step of determining a movement.

9. The ground engaging vehicle of claim 8, wherein said algorithm is executed a plurality of times for each time a new one of said GPS output is available.

10. The ground engaging vehicle of claim 9, wherein said plurality of times is at least 10 times.

11. The ground engaging vehicle of claim 9, wherein said algorithm further includes the step of obtaining a position of said actuator from said position sensor.

12. The ground engaging vehicle of claim 11, wherein said moving step and said obtaining step are executed a plurality of times for each time said receiving step of said algorithm is executed.

13. The ground engaging vehicle of claim 12, wherein said moving step and said obtaining step minimize said difference between said current position and said desired position of said cutting edge in less time than a new output can be obtained from said GPS.

14. The ground engaging vehicle of claim 13, wherein said obtaining step includes the step of receiving a signal from said position sensor associated with said actuator, said signal being analogous to a position of said actuator.

15. A method of adjusting a cutting edge being propelled by a ground engaging vehicle, comprising the steps of
associating a position of the cutting edge with a position of an actuator operatively connected to the cutting edge;
receiving an updated Global Positioning System (GPS) output relative to a position of the cutting edge;
determining a difference between a current position and a desired position of the cutting edge; and
sending a command containing said difference to a non-GPS constrained algorithm, said algorithm including the steps of:
receiving said command;
determining a movement of said actuator dependent on said difference; and
moving said actuator dependent upon said step of determining a movement.

16. The method of claim 15, wherein said algorithm is executed a plurality of times for each time a new one of said GPS output is available.

17. The method of claim 16, wherein said plurality of times is at least 10 times.

18. The method of claim 16, further comprising a further step in said algorithm of obtaining a position of said actuator.

19. The method of claim 18, wherein said moving step and said obtaining step are executed a plurality of times for each time said receiving step of said algorithm is executed.

20. The method of claim 19, wherein said moving step and said obtaining step minimize said difference between said current position and said desired position of the cutting edge in less time than an update can be obtained from said GPS.
